(19) United States
(12) Patent Application Publication
(10) Pub. No.: US 2003/0036324 A1
(43) Pub. Date: Feb. 20, 2003

(54) Composite material resistant to high temperatures

(75) Inventors: Michel Davidovics, Pont-Sainte Maxence (FR); Christophe Buchler, Compiegne (FR)

Correspondence Address: SCHNADER HARRISON SEGAL & LEWIS, LLP, 1600 MARKET STREET, SUITE 3600, PHILADELPHIA, PA, 19103

(73) Assignee: Societe Geopolymere, Brenouille (FR)

(21) Appl. No.: 10/225,697

(22) Filed: Aug. 22, 2002

Related U.S. Application Data
(63) Continuation of application No. PCT/FR01/00667, filed on Mar. 6, 2001.

(30) Foreign Application Priority Data
Mar. 6, 2000 (FR) FR 00/02940

(51) Int. Cl. B32B 3/00; B32B 5/02; B32B 9/00

(52) U.S. Cl. 442/59

(57) ABSTRACT

A composite material resistant to high temperatures including at least one layer of a fibrous textile reinforcement composed of metallic fibers of a diameter smaller than about 30 microns, and a thermosetting ceramic matrix impregnating the fibrous textile reinforcement, which matrix is based on a sialate or polysialate resin.

### RELATED APPLICATION

This is a continuation of International Application No. PCT/FR01/00667, with an international filing date of Mar. 6, 2001, which is based on French Patent Application No. FR 00/02940, filed Mar. 6, 2000.

### FIELD OF THE INVENTION

This invention relates to a laminated composite material resistant to high temperatures intended for the manufacture of mechanical parts or units that can contain, maintain, support or move hot objects during their manufacture, especially glass objects. The invention also relates to a process for producing said parts or units.

### BACKGROUND

Numerous industries need to manufacture their products at high temperatures: manufacture of flat glass, manufacture of hollow glass and manufacture of metal products by various processes. Objects manufactured at high temperatures are contained, maintained, supported and moved at high temperatures. Such operations are hereinafter referred to as “handling”. Examples include:

Hollow glass: circulation of the parisons, extraction of objects from the molds and transport along production lines to the outlet of the annealing means.

Flat glass: transport and cooling of the glass ribbon in the cooling tunnels.

Metal working: transport of aluminum sections during manufacture, hardening, manufacture of steel plates and the like.

Insulation of press plates to be used for shaping hot objects.

The materials intended for handling hot objects during their manufacture respond to many requirements:

Resistance to high temperatures (>250° C.) for extended periods of time.

Resistance to thermal shock.

Compatibility with the material constituting the transported hot object: hot objects are fragile during the manufacturing process. The material in contact with the objects being handled must not damage them by mechanical action (scratches, holes or the like) nor react chemically with the material constituting the hot objects being manufactured.

Machinability: materials intended for handling hot objects during their manufacture must be machinable since the parts constituting the mechanical units such as the conveyors of hot objects have extremely varied forms. Machining can include polishing the materials.

Thermoforming: the materials should preferably by thermoformable to facilitate machining or to use the material to be machined in a cost-effective manner.

Rigidity: in most cases, the materials intended for handling hot objects during their manufacture must be sufficiently rigid so to not be deformed under the weight of the hot objects.

Good mechanical characteristics: the materials intended for handling hot objects during their manufacture must possess mechanical characteristics adequate for supporting the stresses of an industrial environment (shocks, frequent assembly and disassembly of parts). The mechanical characteristics must also be adequate such that the material does not yield under the weight or repeated passage of the hot objects during their manufacture.

Thermal insulation: the materials in contact with hot objects during their manufacture must be thermally insulating to avoid propagation of heat to the other elements of the mechanical assembly and also so as not to damage by thermal shock the hot objects being handled.

Compliance with toxicological standards: the materials intended for handling hot objects during their manufacture must not contain carcinogenic products (asbestos fibers in particular).

There are no materials at present fulfilling all of these requirements. Thus:

Metals cannot be used when good thermal insulation is required.

Ceramics are fragile and sensitive to mechanical shocks. Moreover, ceramics are often difficult to machine.

Products with a hydraulic matrix are not resistant to high temperatures and are also fragile.

Rigid boards based on mineral fibers wear out quickly and do not possess high mechanical characteristics.

Materials based on organic fibers, organic binders and silicone cannot withstand high temperatures: they are very strongly degraded above 250° C.

Graphite-based products or carbon-based composites undergo oxidation at 250° C. which significantly diminishes their useful life in installations not operating in an inert medium.

Fiber-cement type products exhibit very little mechanical resistance.

Products based on asbestos fibers are dangerous from a health point of view.

Known in the prior art are PCT applications WO 88/02741 and WO 96/28398 which describe the manufacture of composites with ceramic, carbon or graphite fibers and a matrix based on sialate or polysialate resin. These materials exhibit good resistance to high temperatures, but their fragile nature and poor machinability make them unsuitable for the manufacture of parts and tools intended for handling hot products during their manufacture.

Thus, it would be advantageous to provide a new material that is resistant to high temperatures and does not exhibit the disadvantages set forth above.

### SUMMARY OF THE INVENTION

This invention relates to a composite material resistant to high temperatures including at least one layer of a fibrous textile reinforcement composed of metallic fibers of a diameter smaller than about 30 microns, and a thermosetting ceramic matrix impregnating the fibrous textile reinforcement, which matrix is based on a sialate or polysialate resin.

### DETAILED DESCRIPTION

The problems described above are overcome by means of a material composed of one or more layers of a fibrous reinforcement based on fine metallic fibers, which layers are impregnated one by one by a ceramic matrix that can be thermoset after impregnation, the matrix preferably being based on a resin of the sialate or polysialate type.

Thus, more particularly, the invention is a composite material resistant to high temperatures, comprising at least one layer of a fibrous textile reinforcement composed of metallic fibers of a diameter smaller than about 30 microns, the fibrous textile reinforcement being impregnated by a ceramic matrix that can be thermoset after impregnation, which matrix is based on a resin of the sialate or polysialate type.

“Textile”, as used hereinafter, is understood to mean the fact that the fibers of the fibrous textile reinforcement are organized, e.g., in felt or knit form.

The resin of the sialate or polysialate type, which is the base of the ceramic matrix that can be thermoset after impregnation, can possibly contain fillers commonly used with these resins. Such fillers are not necessary.

The composite material according to the invention possesses not only good resistance to high temperatures, but also good mechanical characteristics even after prolonged contact with high-temperature objects. The material according to the invention is not fragile. It is more shock resistant than the composite materials based on sialate and polysialate resin described in the prior art and, especially, is more suitable for machining. Unexpectedly for a material based on metallic fibers, it even possesses good insulation properties despite the thermal conductibility of the metal, and it does not score the hot glass. This surprising behavior stems notably from the fineness of the fibers used, of a diameter smaller than about 30 microns, and preferably smaller than about 12 microns. Furthermore, this fiber diameter ensures that the fibers will not protrude from the material and, thus, provides the advantage of not marking the glass objects that are handled by devices constituted of the material.

French Patent Application No. 2,659,963 mentions the use of metallic fibers incorporated in a composite material comprising sialate or polysialate resins. However, that application does not describe the possible use of metallic fibrous reinforcements for materials intended for handling hot objects during their manufacture and does not suggest the nature of fibrous reinforcements that could respond to the specific requirements for this function such as machinability or problems of compatibility with the transported material.

According to one particular form of implementation, the fibrous textile reinforcement comprises at least one layer composed of a mixture of metallic fibers of diameter smaller than about 30 microns and organic and/or mineral fibers, the fibrous textile reinforcement being impregnated by a ceramic matrix that can be thermoset after impregnation, the matrix being based on a resin of the sialate or polysialate type.

The quantity of fibers is typically on the order of about 5 to about 60% by weight in relation to the mass of composite material, and preferably about 8 to about 40% to obtain the best characteristics, for a content of about 40 to about 95% by weight in relation to the mass of composite material of a matrix based on resin of the polycondensed sialate or polysialate type.

The fibrous textile reinforcement used in the constitution of the material according to the invention is a woven fabric, a felt, a nonwoven fabric (possibly reinforced by a woven fabric or a woven mesh) composed solely of metallic fibers or a mixture of metallic fibers with organic fibers (para-aramid, notably) and/or mineral fibers. The metallic fibers constituting the fibrous reinforcement used in the manufacture of the material are preferably made of stainless steel and of a diameter smaller than about 30 microns, and more particularly smaller than about 12 μm. The best results were obtained with needled nonwoven fabrics constituted of stainless steel fibers, the diameter of the fibers being between about 8 and about 12 microns. The use of needled nonwoven fabrics constituted of a mixture of stainless steel fibers at 70% by weight and para-aramid fibers at 30% by weight also yields good results. Furthermore, metallic fibers made of refractory alloy sold, for example, under the name Inconel®, can also be used when the thermal performance of stainless steel becomes inadequate.

The fibrous textile reinforcement used in the constitution of the composite material according to the invention is selected from the group comprising a woven fabric, a felt, a nonwoven fabric or a nonwoven fabric reinforced by a woven fabric or a woven mesh.

The matrix is a ceramic matrix that can be thermoset after impregnation, preferably based on one of the resins of the sialate or polysialate type described in PCT applications WO 88/02741, WO 91/13830, WO 91/13840 and WO 96/28398 and optionally containing the mineral fillers commonly used with these resins.

The material according to the invention is constituted by one or more layers of fibrous reinforcement based on metallic fibers, the layers are impregnated one by one by a ceramic matrix that can be thermoset after impregnation, preferably based on a resin of the sialate or polysialate type. The impregnation of the fibrous reinforcement based on fine metallic fibers as well as the shaping of the impregnated fibrous reinforcement for the fabrication of a plate, a form or a roll is implemented by the techniques commonly used for the shaping of composite materials.

Thus, the material according to the invention resists temperatures up to about 1000° C. on a contact basis and on the order of about 700° C. on a continuous basis. The term “high temperature” is understood to mean a temperature on the order of about 250° C. and above.

Unlike the materials of the prior art based on sialate or polysialate resin, the material according to the invention not only possesses superior mechanical characteristics at ambient temperature, but above all conserves these mechanical characteristics after repeated thermal stress. Moreover, it possesses excellent machinability: machining of good quality is obtained with conventional tools whereas diamond-charged tools were necessary for machining the materials described in the prior art and which yielded mediocre machining results.

This machinability allows creation by cutting and/or machining of the composite material according to the invention of products in the form of parts or objects intended to be used at high temperatures (above 250° C.), for example, as an element of a mechanical unit. It is also possible to create products or objects comprised only in part of the composite material according to the invention.

The material according to the invention is also suitable for thermoforming for the creation of formed parts or objects intended for the handling of hot objects. Thermoforming can be followed by a machining step. Thus, the invention pertains to the use of a composite material as described above for fabricating parts or objects constituted totally or partially of the composite material, or comprising at least one external surface constituted totally or partially of the composite material.

These can be parts or objects of flat or rounded shape, or even balls, to contain, maintain, support, move and more generally handle objects at high temperatures. These parts are obtained totally or partially by:

cutting and machining

by thermoforming the composite material according to the invention.

Thus, in certain configurations, if the hot article to be transported is in contact with only the surface of the object according to the invention, it is possible to create a sandwich-type laminated composite article in which only one external layer or two external layers of the article are made with the fibrous textile reinforcement. The interior part or the center part is made of a composite with a sialate or polysialate matrix as described in the prior art.

The invention also comprises mechanical units or devices comprising one or more parts or objects comprising a composite material as described above.

The invention pertains most particularly to objects, articles or devices for containing, maintaining, supporting, moving or more generally handling objects at high temperatures composed of glass the temperature of which is higher than about 250° C.

Other advantages and characteristics of the invention are evident from the examples below which are non-limiting in nature and are merely representative of selected aspects of the invention.

### EXAMPLE

A disiloxo F-KPSDS polysialate type resin as described in patent WO 91/13840 was prepared by mixing:

a) 100 g of an aqueous solution of potassium silicate of molar ratio K₂O/SiO₂=1, concentrated to 50%,

b) 80 g of fumed silica (15 SiO₂, Al₂O₂),

c) 12 g of hydrated aluminosilicate oxide powder (Al₂, SiO₅),

d) 28 g of sodium fluorosilicate Na₂SiF₆,

e) 40 g of wollastonite powder.

After creation of this mixture, the resin was employed to impregnate very homogeneously two pieces of equal dimension of a needled nonwoven fabric marketed by the company Bekintex as reference NP 200 and constituted of 100% stainless steel fibers 12 μm in diameter. The two pieces were then superposed, taking care to remove the air between the two layers of impregnated nonwoven fabric. This laminate was then put in a press in a plate mold between two pieces of pulling cloths and two plastic films resistant to high temperatures (150° C.) to protect the press plates. The laminate was pressed until obtaining a thickness of 6 mm. The impregnation resin hardened during the pressing phase by heating the press plates according to the following cycle: heat up to 130° C. then hold for 1 hour at 130° C. The quantity of fibers in relation to the mass of composite material was 19.6% by weight. The quantity of polysialate matrix in relation to the mass of composite material was 80.4% by weight. The resultant material possessed the following properties:

Bending strength: 55 MPa

Modulus of elasticity: 13 GPa

The plate can be machined with conventional tools. In contrast to the polysialate resin-based materials described in the prior art, the use of diamond-charged tools is not required.

Possible applications: transfer plates for the transport of hot metal or glass articles during manufacture.

### EXAMPLE 2

A disiloxo K-PSDS polysialate type resin as described in patent WO 91/13830 was prepared by mixing:

a) 100 g of an aqueous solution of potassium silicate of molar ratio K₂O/SiO₂=1, concentrated to 50%,

b) 50 g of aluminosilicate oxide powder (Al₂O₂, SiO₅),

c) 30 g of fumed silica (15 SiO₂, Al₂O₂).

This mixture was employed to contact impregnate three pieces of nonwoven fabric constituted of stainless steel fibers (gradation 316L) of diameter 8 μm (sold by the King's firm as reference KING'S-NF-1006/8-1000). The impregnated nonwoven fabric was passed through a roller dryer to ensure that the impregnation was homogeneous. The three pieces were then superposed inside a single split mold of curved form. The mold was then placed in a compression press and subjected to pressure to bring the laminate in the curved mold to a thickness of 6 mm. The mold was then heated via the press's heating plates according to the following thermal cycle: heat up to 80° C. then hold for 2 hours at 80° C. This produced a part directly thermoformed to the final dimensions without any machining being required. The quantity of stainless steel fibers in relation to the mass of composite material was 30% by weight. The quantity of polysialate matrix in relation to the mass of composite material was 70% by weight.

The composite prepared in this manner does not burn, does not release fumes nor oxidize when it is subjected to temperatures on the order of 700° C. It can resist temperatures of 1000° C. on an intermittent basis.

Possible applications: holding or pushing parts for hot glassware article.

### EXAMPLE 3

A resin was prepared in the same manner as Example 2 above and the resulting resin was used to impregnate to saturation a long piece of nonwoven fabric reinforced by a woven fabric, the unit being constituted by stainless steel fibers (gradation 316L) of diameter 8 μm (sold by the King's firm as reference KING'S-NF-1006/8-1000S). The nonwoven fabric reinforced by a woven fabric impregnated in this manner was rolled around a PVC mandrel, then the mandrel covered with the impregnated nonwoven fabric was placed in an oven at 80° C. saturated in moisture for 6 hours.

After this heat treatment, the composite was removed from the mandrel. The material fabricated in this manner supports contact temperatures of 1000° C. It does not burn and does not release fumes at these temperatures; it can be polished and also cut into rings. The quantity of fibers in relation to the mass of composite material was less than 20% by weight.

Possible applications: covering for the metal rolls used in the annealing tunnels for the manufacture of flat glass. Fabrication of composite rolls for the manufacture of printed glass or steel.

### EXAMPLE 4

A resin was prepared in the same manner as Example 2 above, and this resin was used to impregnate a piece of nonwoven fabric composed of 70% by weight of stainless steel fibers (diameter 8 μm) and 30% by weight of para-aramid fibers (1.5 denier) (sold by the King's firm as reference KING'S-NF-706/8-400). This piece of impregnated nonwoven fabric was pressed with a press equipped with heated plates (at 80° C.) to reach a thickness of 2 mm. After remaining under hot press for 1 hour, the resin was polymerized. This yielded a fine, flexible material that is very easily machined and which conserves good mechanical characteristics even at high temperatures (in particular, the material is shock resistant). The quantity of stainless steel fibers was 8.2% by weight and the quantity of polymineral matrix was 88.2% by weight.

Possible application: fine take-out tongs in the hollow glass industry.

1. A composite material resistant to high temperatures comprising:
at least one layer of a fibrous textile reinforcement composed of metallic fibers of a diameter smaller than about 30 microns; and
a thermosetting ceramic matrix impregnating the fibrous textile reinforcement, which matrix is based on a sialate or polysialate resin.

2. The composite material according to claim 1, wherein the metallic fibers are made of stainless steel and/or a refractory alloy containing nickel.

3. The composite material according to claim 1, wherein the fibrous textile reinforcement is a woven fabric.

4. The composite material according to claim 1, wherein the fibrous textile reinforcement is a felt.

5. The composite material according to claim 1, wherein the fibrous textile reinforcement is a nonwoven fabric.

6. The composite material according to claim 1, wherein the fibrous textile reinforcement is a nonwoven fabric reinforced by a woven fabric or a woven mesh.

7. A composite material resistant to high temperatures comprising at least one layer of a fibrous textile reinforcement composed of metallic fibers of a diameter smaller than about 30 microns and organic and/or mineral fibers, the fibrous textile reinforcement being impregnated by a ceramic matrix that can be thermoset after impregnation, which matrix is based on a sialate or polysialate resin.

8. The composite material according to claim 7, wherein the metallic fibers are made of stainless steel and/or a refractory alloy containing nickel.

9. The composite material according to claim 7, wherein the fibrous textile reinforcement is a woven fabric.

10. The composite material according to claim 7, wherein the fibrous textile reinforcement is a felt.

11. The composite material according to claim 7, wherein the fibrous textile reinforcement is a nonwoven fabric.

12. The composite material according to claim 7, wherein the fibrous textile reinforcement is a nonwoven fabric reinforced by a woven fabric or a woven mesh.

13. An object for handling hot articles totally or partially comprising the composite material according to claim 1.

14. An object for handling hot articles having at least one external surface constituted totally or partially of the composite material according to claim 1.

15. A laminated object comprising one external layer or two external layers made from the composite material according to claim 1.

16. A part for containing, maintaining, supporting, moving or more generally handling objects at high temperatures at least partially comprising the composite material according to claim 1.

17. A part for containing, maintaining, supporting, moving or more generally handling objects at high temperatures obtained entirely or partially by cutting and/or machining a composite material according to claim 1.

18. A part for supporting, transporting or handling objects at high temperatures obtained entirely or partially by thermoforming the composite material according to claim 1.

19. A mechanical assembly comprising one or more parts according to claim 16.

20. A mechanical assembly comprising one or more objects according to claim 16.
